(19) United States
(12) Patent Application Publication
(10) Pub. No.: US 2007/0064670 A1
(43) Pub. Date: Mar. 22, 2007

(54) Method and system for selective silencing in a WLAN mesh network

(75) Inventors: Sung-Won Lee, Seoul (KR); Rakesh Taori, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/505,909

(22) Filed: Aug. 18, 2006

Related U.S. Application Data
(60) Provisional application No. 60/709,119, filed on Aug. 18, 2005.

(30) Foreign Application Priority Data
Jun. 28, 2006 (KR) 2006-58925
Aug. 17, 2006 (KR) 2006-77637

(51) Int. Cl. H04J 3/24

(52) U.S. Cl. 370/349

(57) ABSTRACT

A method and system for selective silencing in a WLAN mesh network are provided. In the selective silencing method, a node being silenced is distinguished from a node being activated. The mechanism for selectively silencing is activated by altering the setting of a bit (or bits) in the frame control field of the control frame. A control frame, including the bits with the pre-specified setting, is sent, with a destination set to a transmitter of the control frame.

### CROSS-REFERENCE TO RELATED PATENT APPLICATION

This application claims priority under 35 U.S.C. § 119(e) of an application filed in the US Patent and Trademark Office on Aug. 18, 2005 and assigned Ser. No. 60/709,119, an application filed in the Korean Patent and Trademark Office on Jun. 28, 2006 and assigned Serial No. 2006-58925, and an application filed in the Korea Intellectual Property Office on Aug. 17, 2006 and assigned Serial No. 2006-77637, the entire disclosure of which is hereby incorporated by reference.

### BACKGROUND OF THE INVENTION

1. Field of the Invention

The present invention relates generally to a method and system for selective silencing in a Wireless Local Area Network (WLAN) mesh network. More particularly, the present invention relates to a method and system for silencing a Station (STA) (i.e. a node that is not capable of forwarding/relaying traffic on behalf of other WLAN devices) while activating a mesh point (MP) (i.e. a node in a WLAN network that is capable of relaying and forwarding traffic on behalf of other MPs) using a control frame.

2. Description of the Related Art

A WLAN mesh network is based on an Institute of Electrical and Electronics Engineers (IEEE) 802.11 Distribution System and Wireless Distribution System (WDS). The WLAN mesh network is comprised of two or more interconnected Base Service Sets (BSSs) which communicate with each other via mesh links using the WLAN mesh service.

An Access Point (AP) is an entity that provides access to a distribution service to an STA connected to the AP via a wireless medium. A Mesh Access Point (MAP) is an MP that contains the AP functionality in the mesh network.

In a mesh network, it may be desirable in certain situations to permit temporary exclusive channel access to MPs without being interrupted by STAs. This is a problem, however. Existing WLAN systems facilitate uninterrupted message exchange between two nodes by means of network allocation vector (NAV). Frames carry a ‘duration field’ indicating the anticipated duration of the message and all receivers except the intended destination set the NAV thereby refraining from transmitting until the NAV expires. Existing control frames do not cater specifically for control functionality for the mesh network. If the control frame is modified to also have the mesh control functionality, the STA may not function with the existing hardware, or may require significant hardware modifications. Moreover, if the STA behaves in correspondence with the control functionality of the control frame, this modified control frame adds to the amount of control information, thereby decreasing network efficiency.

Accordingly, there is a need for an improved system and method for selectively silencing STAs using an existing control frame, while retaining the MPs to continue communicating, to improve network efficiency.

### SUMMARY OF THE INVENTION

An aspect of exemplary embodiments of the present invention is to address at least the above problems and/or disadvantages and to provide at least the advantages below. Accordingly, an aspect of exemplary embodiments of the present invention is to provide a selective silencing method for silencing an STA by Clear-To-Send (CTS)-to-Self using an existing control frame, CTS frame in an MP or an MAP so that only the MP is activated without interruption of mesh network traffic from the STA.

The CTS frame can be replaced by any other control frame including a silencing duration field, and the MP or the MAP can activate only the MP, silencing the STA.

One aspect of an exemplary embodiment of the present invention provides a selective silencing method in a WLAN mesh network. Any one of a bit and a group of bits is set to indicating Wireless Distribution system for distinguishing a node being silenced from a node being activated. A control frame including the conventional duration field is sent, with a destination set to a transmitter of the control frame.

According to another aspect of an exemplary embodiment of the present invention, in a silencing method in an STA in a WLAN, the STA receives a control frame and sets a NAV to the value of a duration field in the control frame, if a (To DS, From DS) value in the control frame is not (0,0).

According to a further aspect of an exemplary embodiment of the present invention, in an activation method in an MP in a WLAN, the MP receives a control frame. If a (To DS, From DS) value in the control frame is not (0,0), the MP does not updates a NAV.

According to still another aspect of an exemplary embodiment of the present invention, in a selective silencing system in a WLAN mesh network, an MAP sets a (To DS, From DS) value in the control frame to be different from (0,0) and sends a control frame with a destination set to the MAP. An STA receives the control frame and sets a Network Allocation Vector to the value of the duration field. An MP receives the control frame, and does not update a NAV.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 illustrates MAP, MP and STA entities according to an exemplary embodiment of the present invention;

FIG. 2 illustrates the structure of a CTS frame according to an exemplary embodiment of the present invention;

FIG. 3 illustrates the structure of a Frame Control field according to an exemplary embodiment of the present invention;

FIG. 4 is a flowchart illustrating a selective silencing operation according to an exemplary embodiment of the present invention;

FIG. 5 is a flowchart illustrating an operation for silencing the STA according to an exemplary embodiment of the present invention; and

FIG. 6 is a flowchart illustrating an activation operation in the MP according to an exemplary embodiment of the present invention.

Throughout the drawings, the same drawing reference numerals will be understood to refer to the same elements, features and structures.

### DETAILED DESCRIPTION OF THE EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications described herein can be made without departing from the scope and spirit of the invention. Also, descriptions of well-known functions and constructions are omitted for clarity and conciseness.

Entities of the Invention: MAP, MP and STA

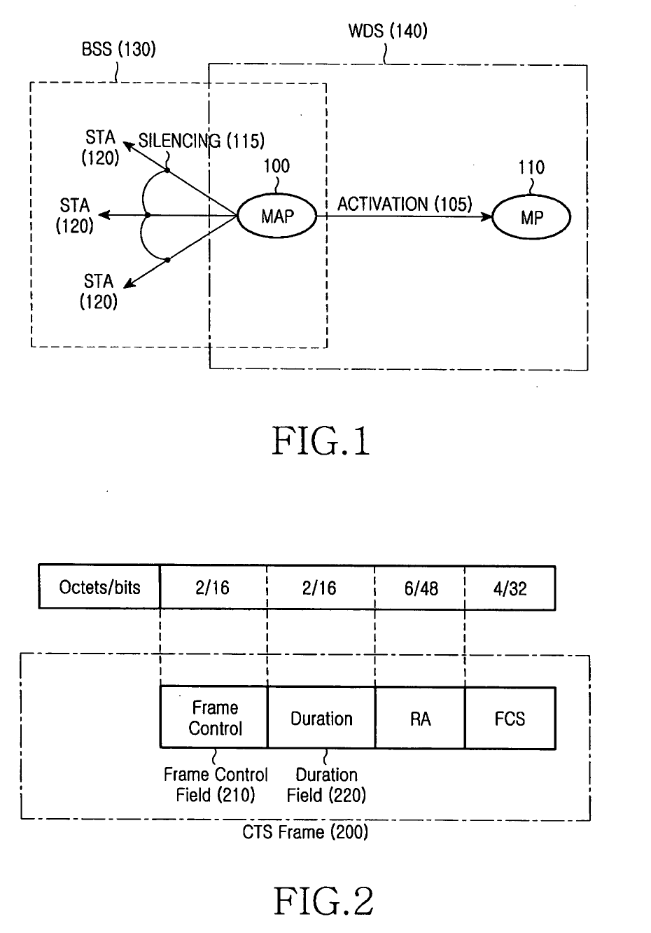

FIG. 1 illustrates MAP, MP and STA entities according to an exemplary embodiment of the present invention.

Referring to FIG. 1, an MAP 100 is a node with AP functionality in a mesh network, and an MP 110 is a mesh node without the AP functionality. The MAP 100 and the MP 110 form a WDS 140.

An STA 120 is a node for sending and receiving IEEE 802.11 messages, without the AP functionality. The STA 120 and the MAP 100 collectively form a BSS 130.

An exemplary embodiment of the present invention is intended to activate traffic in the WDS 140 as indicated by reference numeral 105 and silence traffic in the BSS 130 as indicated by reference numeral 115. An exemplary embodiment of the present invention also enables the selective silencing without any modification to the structure of a conventional control frame, CTS.

CTS Frame

FIG. 2 illustrates the structure of a CTS frame according to an exemplary embodiment of the present invention. In accordance with an exemplary embodiment of the present invention, the MAP 100 or the MP 110 carries out selective silencing by CTS-to-Self. The CTS-to-Self is a CTS frame with a Remote Address (RA) set to the Medium Access Control (MAC) address of a transmitter. An exemplary embodiment of the present invention is associated with a Frame Control field 210 and a Duration field 220 in a CTS frame 200. The Frame Control field 210 distinguishes the BSS 130 from the WDS 140 using (To DS, From DS). The Duration field 220 is used to allocate NAVs to the STA 120 and the MP 110. While an exemplary embodiment of the present invention is described in the context of the CTS frame as a major example of a control frame and the (To DS, From DS) as a major example of the activation or silencing mechanism. The CTS frame can be replaced with any other control frame and the (To DS, From DS) can be replaced by any other bits or flag.

Frame Control Field of CTS Frame

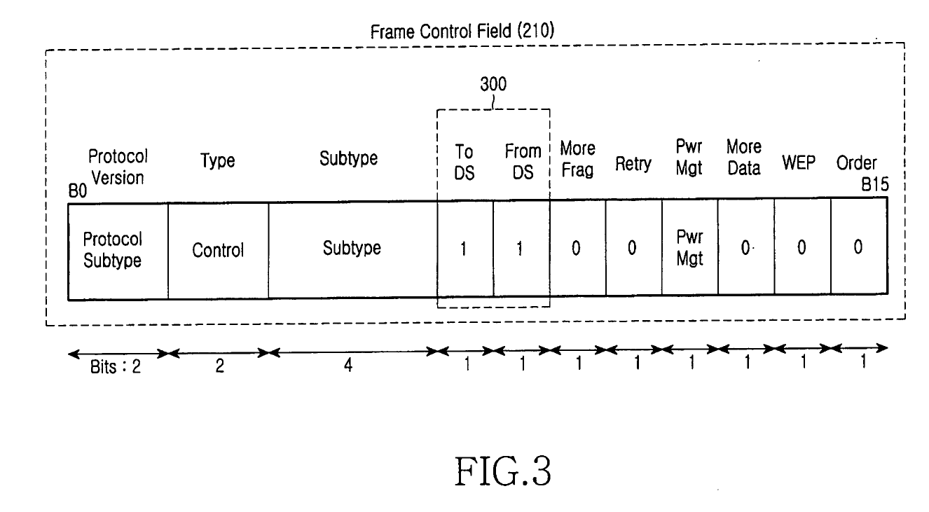

FIG. 3 illustrates the structure of the Frame Control field according to an exemplary embodiment of the present invention. The Frame Control field 210, which is set in the CTS frame 200, contains (To DS, From DS) 300.

Typically, if (To DS, From DS) is (0,0), it indicates BSS traffic between STAs 120. This value is set in a management frame and a control frame. Any other value, for example, (To DS, From DS)=(1,0) or (To DS, From DS)=(0, 1) is set in an incoming data frame to the DS or an outgoing data frame from the DS.

In accordance with an exemplary embodiment of the present invention, when (To DS, From DS) is set to a value other than (0,0), it implies that the control frame is used for communications between the MAP 100 and the MP 110 in the WDS, that is, the mesh network. In other words, if (To DS, From DS) is not (0,0), the function of the control frame is extended for communications between the MAP 100 and the MP 110.

STA Silencing and MP Activation by NAV Allocation

According to an exemplary embodiment of the present invention, the MAP 100 sets (To DS, From DS) to a value other than (0,0) to indicate mesh traffic for which only the MP 110 is to be activated.

The STA 120 sets its NAV to the value of the Duration field, for example, 305 is represented as 000_{—}0001_{—}0011_{—}0001. For 305 μs, the STA 120 is kept silent.

On the other hand, the MP 110 sets a NAV to 0, if (To DS, From DS) is set to a value other than (0,0). Thus, the MP 110 does not update the NAV and the MP 110 can send its data frame after a time period indicated by the previous NAV without waiting.

Selective Silencing by MAP

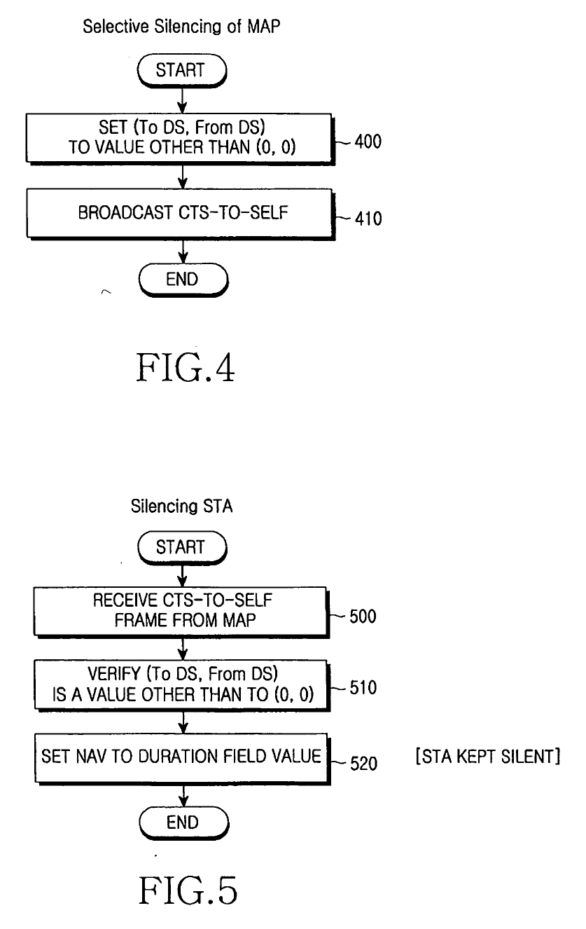

FIG. 4 is a flowchart illustrating a selective silencing operation in the MAP according to an exemplary embodiment of the present invention. Since the MP and the MAP can perform the CTS-to-Self scheme, the selective silencing operation of the MAP is applicable to the MP.

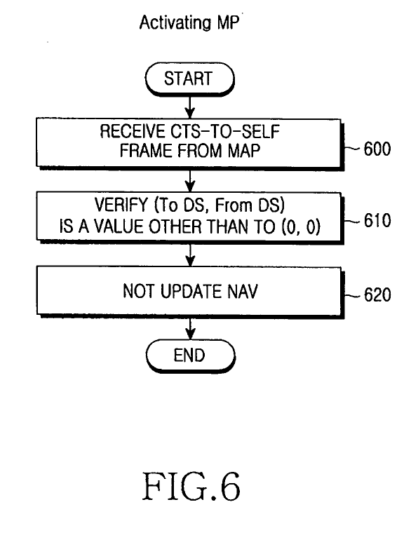

Referring to FIG. 4, in step 400, the MAP 100 sets (To DS, From DS) to a value other than (0,0) to indicate mesh traffic. The MAP 100 sends (broadcasts) the CTS-to-Self frame in step 410. Notably, the CTS frame can be replaced by any other control frame and the (To DS, From DS) field can be replaced by any other field or fields. The MP 110 and the STA 120 receive the CTS frame. The selective silencing associated with the CTS frame reception will be described below with reference to FIGS. 5 and 6.

STA Silencing

FIG. 5 is a flowchart illustrating an operation for silencing the STA according to an exemplary embodiment of the present invention.

Referring to FIG. 5, the STA 120 receives the CTS frame broadcast from the MAP 100 in step 500. The CTS frame has (To DS, From DS) set to other value than (0,0).

The STA 120 may determine that the CTS frame is followed by mesh network traffic by verifying that (To DS, From DS) is not (0,0). Regardless of this determination, in step 510, the STA 120 updates its NAV according to the value of the Duration field of the CTS frame so that it can be silenced for a time period indicated by the MAP 100.

MP Activation

FIG. 6 is a flowchart illustrating an activation operation in the MP according to an exemplary embodiment of the present invention.

Referring to FIG. 6, the MP 110 receives the CTS frame sent by the MAP 100 in step 600 and verifies that (To DS, From DS) in the CTS-to-Self frame is not (0,0) in step 610. For example, if (To DS, From DS) is set to (1, 1), the MP 110 finds out that (To DS, From DS) is set to a value other than (0,0). Hence, the MP 110 recognizes that this traffic is for the mesh network only. In step 620, the MP 110 does not update its NAV.

In accordance with an exemplary embodiment of the present invention as described above, the selective silencing scheme facilitates the silencing of an STA by activating an MP.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A selective silencing method in a Wireless Local Area Network (WLAN) mesh network, comprising:
setting any one of a bit and a group of bits indicating Wireless Distribution System (WDS) traffic in a control frame for distinguishing a node being silenced from a node being activated; and
sending the control frame including the duration field, with a destination set to a transmitter of the control frame.

2. The selective silencing method according to claim 1, wherein the transmitter is at least one of a Mesh Access Point (MAP) and a Mesh point (MP).

3. The selective silencing method according to claim 1, wherein the control frame is a Clear-To-Send (CTS) frame and the sending comprises sending the CTS frame in a CTS-to-Self manner.

4. The selective silencing method according to claim 1, wherein the distinguishing comprises determining the node to be silenced to be a station (STA) and the node being activated to be an MP.

5. The selective silencing method according to claim 1, wherein the any one of a bit and a group of bits is (To DS, From DS) bits in the frame control field of the control frame.

6. A silencing method in a WLAN mesh network, comprising:
receiving a control frame;
detecting any one of a bit and a group of bits indicating Wireless Distribution System (WDS traffic) in the frame control field of the control frame; and
setting a Network Allocation Vector (NAV) to the value of a duration field in the control frame when detecting.

7. The silencing method according to claim 6, wherein the silencing method is used for a station (STA).

8. The silencing method according to claim 6, wherein the any one of a bit and a group of bits is (To DS, From DS) bits in the frame control field of the control frame.

9. The silencing method according to claim 8, wherein the (To DS, From DS) sets to a value that is different from (0,0).

10. The silencing method according to claim 6, wherein the control frame comprises a Clear-To-Send (CTS) frame from at least one of a Mesh Point (MP) or a Mesh Access Point (MAP).

11. The silencing method according to claim 6, further comprising maintaining silence for a time period indicated by the duration field in microseconds.

12. An activation method in a WLAN mesh network comprising:
receiving a control frame; and
detecting any one of a bit and a group of bits indicating Wireless Distribution System (WDS traffic), in the frame control field of the control frame; and
not updating the a Network Allocation Vector (NAV) when detecting.

13. The activation method according to claim 12, wherein the activation method is used in a mesh point (MP).

14. The activation method according to claim 12, wherein the any one of a bit and a group of bits is (To DS, From DS) bits in the frame control field of the control frame.

15. The activation method according to claim 14, wherein the (To DS, From DS) sets to a value that is different from (0,0).

16. The activation method according to claim 12, wherein the control frame comprises a CTS frame from at least one of an MP or an MAP.

17. A selective silencing system in a Wireless Local Area Network (WLAN) mesh network, comprising:
a Mesh Access Point (MAP) for setting any one of a bit and a group of bits indicating Wireless Distribution Traffic (WDS), in the frame control field of a control frame and sending the control frame, with a destination set to the MAP;
a station (STA) for receiving the control frame and setting a Network Allocation Vector (NAV) to the value of the duration field; and
a Mesh Point (MP) for receiving the control frame, and not updating a NAV.

18. The system according to claim 17, wherein the any one of a bit and a group of bits is (To DS, From DS) bits in the frame control field of the control frame.

19. The system according to claim 18, wherein the (To DS, From DS) set to a value that is different from (0,0)

20. The system according to claim 17, wherein the MAP and the MP form a Wireless Distribution System (WDS).
